(19) United States
(12) Patent Application Publication
(10) Pub. No.: US 2022/0197371 A1
(43) Pub. Date: Jun. 23, 2022

(54) INTERACTIVE DISPLAY SYSTEM AND METHOD FOR INTERACTIVELY PRESENTING HOLOGRAPHIC IMAGE

(71) Applicant: SA Incubator, LLC, Princeton, NJ (US)

(72) Inventors: Susan Press, Princeton, NJ (US); Alberto Washington, Princeton, NJ (US)

(21) Appl. No.: 17/554,311

(22) Filed: Dec. 17, 2021

Related U.S. Application Data
(60) Provisional application No. 63/127,225, filed on Dec. 18, 2020.

(51) Int. Cl. G06F 3/01; G02B 5/32; G02B 30/56

(52) U.S. Cl. CPC G06F 3/011; G02B 30/56; G02B 5/32

(57) ABSTRACT

Disclosed is an interactive display system. The interactive display system comprises image source(s), a holographic optical element that is capable of converting images into holographic images, a frame designed to accommodate the holographic optical element therein, sensor(s) and a processor operably coupled to the image source(s) and the sensor(s). The processor is configured to: obtain sensor data generated by the sensor(s), wherein the sensor data is indicative of an input. Moreover, process the sensor data to determine the input; generate an image, based on the input; and control the image source(s) to display the image, wherein light rays emanating from the image source(s) are reflected by the holographic optical element to provide a holographic image in air, and wherein the holographic image represents virtual object(s).

### TECHNICAL FIELD

The present disclosure relates to interactive display systems for presenting holographic images. The present application relates to an interactive display system and a method of interactively presenting a holographic image using the interactive display system.

### BACKGROUND

In the past few decades, extended reality (XR) technologies such as virtual reality (VR), augmented reality (AR), mixed reality (MR), and the like, have made exponential advancements in the way such technologies present visual environments to users of specialized devices. Presently, XR environments are experienced by the users using dedicated XR devices such as XR headsets, XR glasses, XR-based computing devices (such as XR-based smartphones or tablets), and the like. These XR devices act as a window through which the XR environments are viewed and therefore limit the users to being in the proximity of these XR devices to be able to view the XR environments.

Nowadays XR devices are increasingly employing holography to present multi-dimensional holograms in the XR environments. However, such holographic devices suffer from several limitations. Firstly, some of these devices are bulky and utilize industrial-size hardware to create three-dimensional (3D) holographic image. Additionally, such an arrangement limits the portability and consequently limits the real-world applicability. Secondly, some of these devices do not allow movement of the holographic image (for example, hologram may not be able to move 360 degrees). Thirdly, existing technologies enable very limited interaction between hologram and users of such devices. Additionally, such an arrangement provides a suboptimal usage experience (non-immersive, non-realistic).

Therefore, in light of the foregoing discussion, there exists a need to overcome the aforementioned drawbacks associated with the existing devices employing holography.

### SUMMARY

One object of the teachings herein is to overcome or at least mitigate the problems of the prior art.

As the inventors have realised after inventive and insightful reasoning, there are problems, as are discussed briefly above, in that existing holographic interactive display systems are bulky and utilize industrial-size hardware. Additionally, they are not portable and in turn limits their usability in several environments.

According to one aspect, the present disclosure provides an interactive display system comprising:

at least one image source;
a holographic optical element that is capable of converting images into holographic images;
a frame designed to accommodate the holographic optical element therein, wherein the frame, in use, arranges the holographic optical element at a first distance from the at least one image source and obliquely with respect to the at least one image source;
at least one sensor; and
a processor operably coupled to the at least one image source and the at least one sensor, wherein the processor is configured to:
obtain sensor data generated by the at least one sensor, wherein the sensor data is indicative of an input;
process the sensor data to determine the input;
generate an image, based on the input; and
control the at least one image source to display the image, wherein upon displaying, light rays emanating from the at least one image source are reflected by the holographic optical element when passing through the holographic optical element, to provide a holographic image in air, and wherein the holographic image represents at least one virtual object.

Embodiments of the present disclosure enable the interactive display system to be small in size and compact in construction. It is therefore portable and can be effectively used in a variety of practical use scenarios. In some practical use scenarios, the interactive display system could be implemented as an attachment that can be attached (securely) to the user device (for example, such as a smartphone, a tablet computer, a smart display, and the like). In addition to generating the holographic image to be displayed and/or customizing the holographic image, based on the input, the processor may be further configured to enable the user to perform several tasks such as zooming-into or zooming-out of at least one virtual object, provide a required pose of at least one virtual object, and the like.

In some embodiments, the input pertains to digital manipulation of the at least one virtual object represented by the holographic image, said digital manipulation comprising at least one of: creation of a given virtual object, removal of a given virtual object, resizing a given virtual object, changing a pose of a given virtual object, modifying a given virtual object, selection of a given virtual object from amongst a plurality of virtual objects.

In some embodiments, when processing the sensor data, the processor employs at least one of: an artificial intelligence algorithm, an image processing algorithm, an audio processing algorithm.

In some embodiments, the holographic image is provided at a second distance from the holographic optical element, the second distance lying in a range of 80 percent to 120 percent of the first distance.

In some embodiments, the holographic optical element is implemented as a transmissive reflector array comprising:
a first configuration of reflective elements, wherein a reflective surface of each reflective element is oriented in a first direction; and
a second configuration of reflective elements stacked on top of the first configuration, wherein a reflective surface of each reflective element is oriented in a second direction, the second direction being orthogonal to the first direction.

In some embodiments, at least one of: movement of the virtual object, a second distance from the holographic optical element at which the holographic image is provided, a size of the holographic image, a viewing angle of viewing the holographic image, depends on a size of the holographic optical element.

In some embodiments, a given sensor is arranged parallel to the at least one image source and at a third distance from the at least one image source, the third distance being different from the first distance.

In some embodiments, the frame is detachably attachable to a device comprising the at least one image source.

In some embodiments, at least one output device, wherein the processor is configured to:
determine, based on the input, an output that is to be provided when displaying the image; and
control the at least one output device to provide the output at a time of displaying the image.

In some embodiments, the processor is communicably coupled to a smart device that employs artificial intelligence, and wherein the processor is further configured to interface with the artificial intelligence of the smart device to at least control the smart device.

Beneficially, the interactive display system could be implemented as a sleek and compact device that can be used in proximity of the smart device that employs artificial intelligence (AI). In such a case, the interactive display system may work seamlessly with the AI of the smart device.

According to another aspect, a method of interactively presenting a holographic image using an interactive display system, the interactive display system comprising at least one image source, a holographic optical element, a frame designed to accommodate the holographic optical element therein, and at least one sensor, the method comprising:
obtaining sensor data generated by the at least one sensor, wherein the sensor data is indicative of an input;
processing the sensor data to determine the input;
generating an image, based on the input; and
controlling the at least one image source to display the image, wherein upon displaying, light rays emanating from the at least one image source are reflected by the holographic optical element when passing through the holographic optical element to provide the holographic image in air, the holographic optical element being arranged in use by the frame at a first distance from the at least one image source and obliquely with respect to the at least one image source, wherein the holographic image represents at least one virtual object.

In some embodiments, processing the sensor data comprises employing at least one of: an artificial intelligence algorithm, an image processing algorithm, an audio processing algorithm.

In some embodiments, the interactive display system further comprises at least one output device, and wherein the method further comprises:
determining, based on the input, an output that is to be provided when displaying the image; and
controlling the at least one output device to provide the output at a time of displaying the image.

In some embodiments, the interactive display system is communicably coupled to a smart device that employs artificial intelligence, and wherein the method further comprises interfacing with the artificial intelligence of the smart device to at least control the smart device.

Beneficially, the interactive display system could be implemented as a sleek and compact device that can be used in proximity of the smart device that employs artificial intelligence (AI). In such a case, the interactive display system may work seamlessly with the AI of the smart device.

According to yet another aspect, a computer program product for implementing a method of interactively presenting a holographic image using an interactive display system, the computer program product comprising a non-transitory machine-readable data storage medium having stored thereon program instructions that, when accessed by a processing device, cause the processing device to:
obtain sensor data generated by at least one sensor, wherein the sensor data is indicative of an input;
process the sensor data to determine the input;
generate an image, based on the input; and
control at least one image source to display the image, wherein upon displaying, light rays emanating from the at least one image source are reflected by a holographic optical element when passing through the holographic optical element to provide the holographic image in air, the holographic optical element being arranged in use by a frame at a first distance from the at least one image source and obliquely with respect to the at least one image source, wherein the holographic image represents at least one virtual object.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is to be read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram of an interactive display system, in accordance with some embodiments of the present disclosure;

FIG. 1B is a block diagram of an interactive display system along with at least one output device, in accordance with some embodiments of the present disclosure;

FIG. 2 is an exemplary schematic of an interactive display system of FIG. 1A, in accordance with some embodiments of the present disclosure;

FIGS. 3A and 3B are an exemplary implementation of a ray diagram of an optical path of a light ray within the holographic optical element and an exemplary implementation of a holographic optical element, respectively, in accordance with some embodiments of the present disclosure;

FIG. 4 is an exemplary implementation of a holographic optical element showing viewing angle, in accordance with some embodiments of the present disclosure;

FIG. 5 is an exemplary implementation of a holographic optical element, in accordance with some embodiments of the present disclosure;

FIG. 6 is another exemplary implementation of a holographic optical element, in accordance with another embodiment of the present disclosure;

FIG. 7 is a side view of an exemplary implementation of a holographic optical element, in accordance with some embodiments of the present disclosure; and

FIG. 8 is a flowchart depicting steps of a method of interactively presenting a holographic image using an interactive display system, in accordance with another embodiment of the present disclosure.

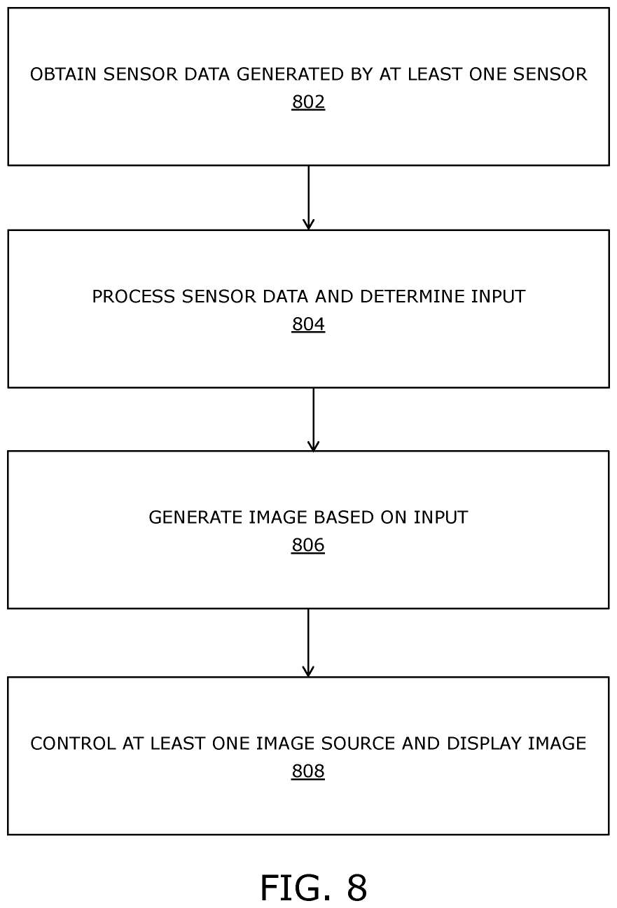

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

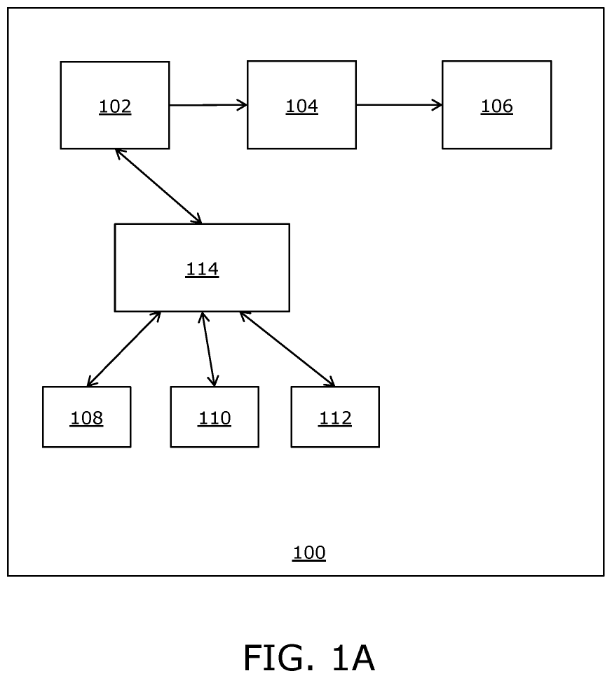

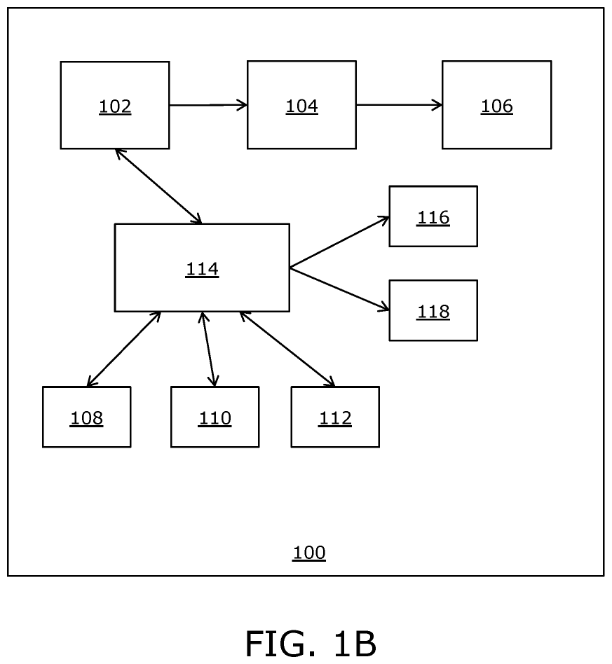

Referring to FIG. 1A, illustrated is a block diagram of an interactive display system, in accordance with some embodiments of the present disclosure. With reference to FIG. 1A, there is shown an interactive display system 100. The interactive display system 100 comprises at least one image source 102 and a holographic optical element 104 that is capable of converting images into holographic images. Moreover, a frame 106 designed to accommodate the holographic optical element 104 therein, wherein the frame 106, in use, arranges the holographic optical element 104 at a first distance from the at least one image source 102 and obliquely with respect to the at least one image source 102. Additionally, the interactive display system 100 comprises at least one sensor, such as sensors 108, 110, 112. Furthermore, a processor 114 operably coupled to the at least one image 102 source and the at least one sensor, such as sensors 108, 110, 112. As an example, the sensors 108 and 110 may be image sensors arranged in separate cameras, whereas the sensor 112 may be an audio sensor arranged in a microphone. The processor 114 is configured to obtain sensor data generated by the at least one sensor, such as sensors 108, 110, 112, wherein the sensor data is indicative of an input. Moreover, the processor 114 further processes the sensor data to determine the input and control the at least one image source 102 to display the image, wherein upon displaying, light rays emanating from the at least one image source 102 are reflected by the holographic optical element 104 when passing through the holographic optical element 104, to provide a holographic image in air, and wherein the holographic image represents at least one virtual object.

Referring to FIG. 1B, illustrated is a block diagram of an interactive display system along with at least one output device, in accordance with some embodiments of the present disclosure. With reference to FIG. 1B, there is shown an interactive display system 100. The interactive display system further comprises at least one output device, such as output devices 116, 118. As an example, the sensors 116 may be a LED and 118 may be a loudspeaker. Moreover, the processor 114 is configured to determine, based on the input, an output that is to be provided when displaying the image. The processor 114 is further configured to control the at least one output device, such as output devices 116, 118, to provide the output at a time of displaying the image.

Herein, the at least one image source 102 could be a display, a transmissive projection surface associated with a projector, and the likes. Moreover, the display could be a 2D display, such as a Liquid Crystal Display (LCD), a Light Emitting Diode (LED), an Organic LED (OLED), QLED and the likes, or a 3D display, such as a curved display, a volumetric display, and the likes. Herein, a “volumetric display device” refers to a graphic display device that forms a visual representation of an object in three physical dimensions, as opposed to the planar image of traditional screens that simulate depth through a number of different visual effects. Additionally, volumetric displays create 3D imagery via the emission, scattering, or relaying of illumination from well-defined regions in space. Notably, the at least one image source 102 may emit light of a specific wavelength or a set of wavelengths.

In some embodiments, the interactive display system 100 further comprises at least one output device, such as output devices 116, 118, wherein the processor 114 is configured to: determine, based on the input, an output that is to be provided when displaying the image; and control the at least one output device, such as output devices 116, 118, to provide the output at a time of displaying the image. Notably, the output devices could be implemented as at least one of: a loudspeaker 118, a light-emitting device (LED) 116. As an example, the loudspeaker 118 could be used to provide an audio output corresponding to a virtual assistant (thus making it seem like the virtual assistant is speaking to a user of the interactive display system). In this case, the holographic image represents the virtual assistant. As yet another example, the light-emitting device could be used to provide a visual output (for example, an LED 116 could emit red light when the user provides an invalid input.

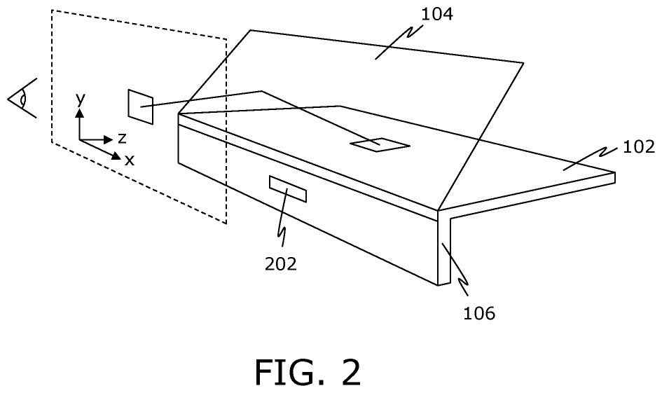

Referring to FIG. 2, illustrated is an exemplary schematic of interactive display system 100 of FIG. 1A, in accordance with some embodiments of the present disclosure. With reference to FIG. 2, there is shown the at least one image source 102. Additionally, several light rays emanating from the at least one image source 102 diverge and pass through the holographic optical element 104. After passing, the several light rays converge in mid-air and forms the holographic image right in front of the user. Notably, optical properties and design of the holographic optical element 104 cause the light rays to have such an optical path, for eventually producing the holographic image. Moreover, the holographic optical element 104 is accommodated in the frame 106. Notably, at least one sensor, such as sensor 202, may be incorporated within the frame 106 such that it gets a clear view of the user and is in close proximity of the user.

The holographic optical element 104 refracts the light rays emanating from the at least one image source 102. Notably, as the light rays passes through the holographic optical element 104, the light rays undergo reflection within the holographic optical element 104 and finally exit the holographic optical element 104. In this way, the image from the at least one image source 102 converts into a holographic image. Herein, the light rays, after passing through the holographic optical element 104, converge in mid-air and form the holographic image. Consequently, the image displayed on the least one image source 102 appears to be formed in air. Herein, the angle between the frame 106 and the at least one image source 102 is beneficially between 30 degrees to 90 degrees. Notably, the holographic optical element 104 could be made of glass, plastic, and other refractive materials. Beneficially, plastic will be cheaper to manufacture and more durable as compared to glass.

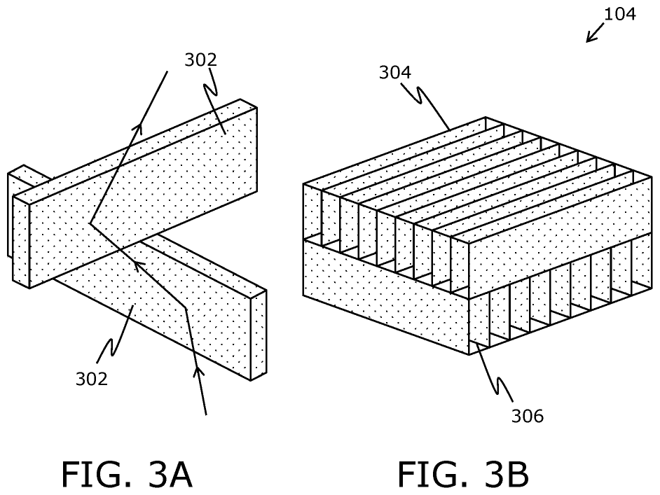

Referring to FIGS. 3A and 3B, illustrated are a ray diagram of an optical path of a light ray within the holographic optical element 104 and an exemplary implementation of a holographic optical element 104, respectively, in accordance with some embodiments of the present disclosure. The holographic optical element 104 contains two layers 304 and 306 of reflective elements 302. The first layer 304 of reflective elements 302 in stacked in one direction and the second layer 306 is stacked in another direction. With reference to FIG. 3A, there is shown a light ray striking a mirrored surface (shown with hatching) of the first layer 304 of the reflective elements 302. After reflection, the light ray strikes the mirrored surface (shown with hatching) of the second layer 306 of the reflective elements 302 and passes onto air. With reference to FIG. 3B, there is shown the stacked reflective items in two layers. The mirrored surface (shown with hatching) of the first layer 304 is placed orthogonal to the second layer 306.

In some embodiments, the holographic optical element 104 is implemented as a transmissive reflector array comprising: a first configuration of reflective elements 302, wherein a reflective surface of each reflective element 302 is oriented in a first direction; and a second configuration of reflective elements 302 stacked on top of the first configuration, wherein a reflective surface of each reflective element 302 is oriented in a second direction, the second direction being orthogonal to the first direction. The reflector array consists of two orthogonal reflective elements that reflect the light to project images. The first angle of incidence and the second angle of emergence both have the same reflection angle, and the plate acts as a projection surface for displaying images in midair at a 1:1 ratio. Moreover, the holographic optical element 104 consists of methodically positioned vertical mirror surfaces. The holographic optical element 104 are measured in hundreds of microns. Herein, mirror surfaces are like that of micromirrors. Micromirrors are devices based on microscopically small mirrors. The mirrors are microelectromechanical systems (MEMS), which means that their states are controlled by applying a voltage between the two electrodes around the mirror arrays.

The holographic optical element 104 is accommodated in a frame 106. Additionally, the frame 106, when in use, arranges the holographic optical element 104 at the first distance from the at least one image source 102. Herein, first distance is the distance between the at least one image source 102 and the holographic optical element 104. Moreover, the frame 106 holds the holographic optical element 104 at an angle such that the light rays emanating from the at least one image source 102 properly strike the holographic optical element 104. Notably, the frame 106 could be a standalone element or a part of the at least one image source 102. Herein, the frame 106 may be made out of plastic, durable alloy, metal and the likes. Consequently, the frame 106 will provide extra protection to the holographic optical element 104 from accidental wear and tear. Notably, the frame 106 is sturdy enough to accommodate the holographic optical element 104. Additionally, optionally, the at least one image source 102 is accommodated in the frame 106. Moreover, technical effect of accommodating both the at least one image source 102 and the holographic optical element 104 in frame 106 is that the system can be handled in an easy manner, is compact, sleek.

In some embodiments, the frame 106 is detachably attachable to a device comprising the at least one image source 102. Herein, the device could be a smartphone, a tablet, a volumetric display, a monitor, and the likes. Notably, the frame 106 may be attached to the device as a flip cover or a phone case. Optionally, a hinge mechanism may be used to open and fold the holographic optical element 104 along with the frame 106. Notably, the frame 106 may be attached to a stand which in turn may be attached to the device.

Optionally, the holographic optical element 104 and the at least one sensor, such as sensors 108, 110, 112 may be a part of the frame 106 as part of the case. Notably, the at least one sensor may be internally attached to the frame 106 such that it is treated as one and the at least one sensor is accommodated compactly in the frame 106. It will be appreciated that the frame size may vary depending on the size of the at least one image source 102.

The interactive display system 100 comprises at least one sensor. Notably, the at least one sensor is implemented as at least one of: an image sensor 108, 110, a distance sensor, an audio sensor 112, a touch sensor, a light sensor, and the likes. The at least one sensor may be arranged externally or optionally in a device. As an example, the image sensor 108, 110 may be arranged in a camera. The distance sensor may also be arranged in the camera, or in a separate device. As another example, the audio sensor 112 may be arranged in a microphone. The sensor data generated by the at least one sensor may include, but is not limited to, images of a real-world environment where the interactive display system 100 is present, distances of various objects in the real-world environment from the interactive display system 100, and speech signals and/or audio signals in the real-world environment. The at least one sensor enables the user to provide the input to the interactive display system and thereby interact with the interactive display system 100. Notably, the interaction between the user and the at least one sensor may be contactless. Additionally, touch sensors are better suited to create a contactless touch environment. Moreover, contactless integration allows interaction to an application or interfaces without having to touch any surface in order to provide a germ-free alternative. Beneficially, such an arrangement will prevent and reduce the spread of bacteria and viruses.

The interactive display system 100 comprises the processor 114 operably coupled to the at least one image source 102 and the at least one sensor, such as sensors 108, 110, 112. The processor 114 is implemented as hardware, software, firmware, or a combination of these.

As an example, the processor 114 may control the at least one image source 102 to emit light constituting the holographic image. The processor 114 performs image generation based on the input (provided interactively by the user) to adjust a pose of the at least one virtual object represented in the holographic image. Herein, the term pose encompasses both position and orientation. The user may view the holographic image from a close proximity or from a far. In an example, the processor 114 may control the at least one virtual object represented by the holographic image within a three-dimensional space, for making the at least one virtual object appear to be moving to the user. In another example, the processor 114 may control an orientation of the at least one virtual object such as the holographic image within the three-dimensional space, for presenting the at least one virtual object at various viewing angles to the user. The at least one virtual object appears to be arranged different from different viewing angles.

In some embodiments, the processor 114 is communicably coupled to a smart device that employs artificial intelligence, and wherein the processor 114 is further configured to interface with the artificial intelligence of the smart device to at least control the smart device. In some practical use scenarios, the interactive display system 100 could be implemented as a sleek and compact device that can be used in proximity of a smart device that employs artificial intelligence (AI). In such a case, the interactive display system 100 may work seamlessly with the AI of the smart device. The smart device may, for example, be a smart virtual assistant (such as Alexa®), a smart speaker, a smart bulb, a smartphone, and the like. The smart device employs AI to perform specialized functions for controlling the smart device such as, but not limited to, data fetching based on voice recognition, appliance control based on audio recognition, and the like. Typically, the user directly interacts with the smart device to control the smart device by way of providing a voice input, a gesture input, and the like, to control the smart device. According to embodiments of the present disclosure, the user can interact with the interactive display system 100 to eventually (indirectly) control the smart device via the interactive display system 100. It will be appreciated that with advancements in technology, the interactive display system 100 may eventually be made small enough to be either a detachable accessory to user devices and/or smart devices, or a part of the user devices and/or the smart devices.

The processor 114 is configured to obtain sensor data generated by the at least one sensor, such as sensors 108, 110, 112, wherein the sensor data is indicative of an input. Notably, the sensor data is indicative of how the user interacts with the device. By obtaining this, user's preference is taken into account for image generation, by the processor. Optionally, the at least one sensor such as sensors 108, 110, 112, is configured to generate the sensor data continuously. Alternatively, optionally, the at least one sensor such as sensors 108, 110, 112, is configured to generate the sensor data at regular intervals or intermittently or when needed by the user.

In an example, the sensor data may include images of the real-world environment wherein such images represent the pose of the user. In another example, the sensor data may include images of the real-world environment, wherein such images represent the gesture of the user. In yet another example, the sensor data may include at least one speech signal, wherein the at least one speech signal corresponds to speech (namely, voice) of the user. In still another example, the sensor data may include at least one audio signal, wherein the at least one audio signal corresponds to an audio provided by an audio-producing object (for example, such as a musical instrument).

In some embodiments, the input pertains to digital manipulation of the at least one virtual object represented by the holographic image, said digital manipulation comprising at least one of: creation of a given virtual object, removal of a given virtual object, resizing a given virtual object, changing a pose of a given virtual object, modifying a given virtual object, selection of a given virtual object from amongst a plurality of virtual objects. Notably, the input is indicative of how to adjust the position and/or the orientation of the at least one virtual object represented by the holographic image. Additionally, the adjustment of the pose of the at least one virtual object, in order to properly present motion of the at least one virtual object to the user, enables the user in examining the holographic image from varied perspectives, and the like. As an example, the sensor data may comprise a speech signal, wherein the speech is, for example, ‘move 5 units left’. At a later time, for example, the sensor data may again comprise a speech signal, and this speech signal may be processed to determine the input pertaining to speech of the user, said speech being, for example, ‘rotate 90 degrees clockwise’.

In some embodiments, a given sensor is arranged parallel to the at least one image source 102 and at a third distance from the at least one image source 102, the third distance being different from the first distance. Notably, the at least one sensor such as sensors 108, 110, 112, is positioned preferably parallel to the at least one image source 102 such that the inputs from the user are easily recorded. Furthermore, the at least one sensor, such as sensors 108, 110, 112, is at a third distance from the at least one image source 102 such that a gap created would allow the user to interact with the interactive display system 100. Notably, the user may interact with the interactive display system 100 by simply hovering the finger. Additionally, the gap would give enough space to the user for interaction without accidently bumping with the at least one sensor, such as sensors 108, 110, 112.

The processor 114 is configured to process the sensor data to determine the input. Notably, the sensor data is processed, by the processor 114, to ascertain the input provided by the user to the interactive display system 100. The at least one sensor, such as sensors 108, 110, 112, enables the user to provide the input to the interactive display system and thereby interact with the interactive display system 100. As an example, the sensor data may comprise an image representing hands of the user. The processor 114 may process the sensor data to determine the input pertaining to a gesture made by the user, wherein the gesture is a show of seven fingers by the user. Based on this input, the processor 114 may select a seventh image for displaying as the holographic image. At a later time, for example, the sensor data may again comprise an image representing hands of the user, and this image may be processed to determine the input pertaining to another gesture made by the user, said gesture being a left swipe gesture made by the user. Based on this input, the processor 114 may select an eighth image (which is next in sequence after the seventh image), for displaying as the holographic image.

It will be appreciated that optionally, in addition to determining the holographic image to be displayed and/or adjusting the pose of the holographic image in a three-dimensional space, the processor 114 may be further configured to perform other processing task(s) based on the input. Such other processing task(s) may include, but are not limited to, manipulating (for example, adjusting a shape, a size, a colour, and the like) at least a portion of the holographic image, zooming-into or zooming-out of the holographic image, controlling a loudspeaker to provide an audio output (for example, to enable the three-dimensional image of an avatar to verbally interact with the user, to provide sounds made by the three-dimensional image of a virtual object in motion, and the like), turning off the interactive display system 100, generating the three-dimensional image, notifying users of incoming calls and/or notifications, transforming two-dimensional images (such as contact images of the user's contacts) into three-dimensional images.

In some embodiments, the processor 114, when processing the sensor data, employs at least one of; an artificial intelligence algorithm, an image processing algorithm, an audio processing algorithm. Optionally, the processor 114 is configured to execute a software application that employs at least one of: an object recognition algorithm, a pattern recognition algorithm, an edge detection algorithm, a pose estimation algorithm, a gesture recognition algorithm, a voice recognition algorithm, an audio recognition and/or processing algorithm. Such AI algorithms are well-known in the art.

The processor 114 is configured to generate an image, based on the input. Notably, the processor 114 generates the image to be displayed, based on the input. The input is indicative of which the image is to be generated for displaying. Herein, the “image” could be a two-dimensional (2D) image or a three-dimensional (3D) image. Notably, the processor 114 employs software technology to create the (3D volume) holographic image. Optionally, for generating the image, the processor 114 employs one of: a point-cloud technique, a surface-panel technique (namely, a polygon-based technique), a layer-based technique, a three-dimensional perspective projection technique. Other techniques for generating the image may optionally be employed.

The processor 114 is configured to control the at least one image source 102 to display the image, wherein upon displaying, light rays emanating from the at least one image source 102 are reflected by the holographic optical element 104 when passing through the holographic optical element 104, to provide the holographic image in air, and wherein the holographic image represents at least one virtual object. In some embodiments, the holographic image is a two-dimensional (2D) image. In other embodiments, the holographic image is a two and a half-dimensional (2.5D) image. In yet other embodiments, the holographic image is a three-dimensional (3D) image. Herein, 2.5D is an effect in visual perception. It is the construction of an apparently three-dimensional environment from 2D retinal projections. While the result is technically 2D, it allows for the illusion of depth. It is easier for the eye to discern the distance between two items than the depth of a single object in the view field. Computers can use 2.5D to make images human faces look lifelike. Notably, the holographic optical element 104 is used for projection to form the holographic image by projecting the rays onto holographic optical element 104 from the at least one image source 102. Additionally, the light rays coming out of the at least one image source 102 is projected on the holographic optical element 104 to form the holographic image in air. Herein, “virtual object” refers to an object that is not physically present in a real-world environment where the interactive display system 100 is being used. Additionally, the virtual object seems to be present in the real-world environment. The virtual object can, for example, be a virtual entity (for example, such as a virtual avatar of the user, a virtual animal, and the like), a virtual navigation tool (for example, such as a virtual map, a virtual direction signage, and the like), a virtual gadget (for example, such as a virtual calculator, a virtual computer, a virtual machinery, a virtual vehicle, and the like), a virtual media (for example, such as a virtual video, a virtual advertisement, and the like), a virtual information, and the like. The virtual avatar may, for example, be a predefined avatar, a customizable (by the user) avatar, a licensed character, or a non-licensed character.

Optionally, the processor 114 is further configured to provide the user with a user interface to enable the user to at least select the holographic image to be displayed and/or customize the holographic image. In some embodiments, the user interface is rendered at the user device associated with the user. In such a case, the processor 114 is communicably coupled to the user device. The user device may, for example, be a smartphone, a tablet computer, a laptop computer, or a desktop computer. The user interface includes visual objects such as icons, cursors, buttons, menus, and the like, that the user uses to interact with the interactive display system 100. The user may interact with the user interface via one or more of: a touch input, an audio input, an image input, an audio-visual input, a speech input, and the like. In another embodiment, the user interface is rendered at a display that is associated with the interactive display system 100. Such a display may be integrated with the interactive display system (for example, it may be arranged on an outer surface of a housing of the interactive display system) or may be remote from the interactive display system 100. In such a case, the processor 114 would be communicably coupled with the display.

It will be appreciated that optionally, in addition to selecting the holographic image to be displayed and/or customizing the holographic image, the processor 114 may be further configured to enable, via the user interface, the user to perform several tasks such as zooming-into or zooming-out of the at least one virtual object in the holographic image, provide a required pose of the at least one virtual object, and the like.

In some embodiments, the holographic image is provided at a second distance from the holographic optical element 104, the second distance lying in a range of 80 percent to 120 percent of the first distance. The second distance may, for example, be from 80, 85, 90, 100 or 110 percent up to 95, 105, 110, 115 or 120 percent. The range of 80 percent to 120 percent will provide the user with an extra viewing angle.

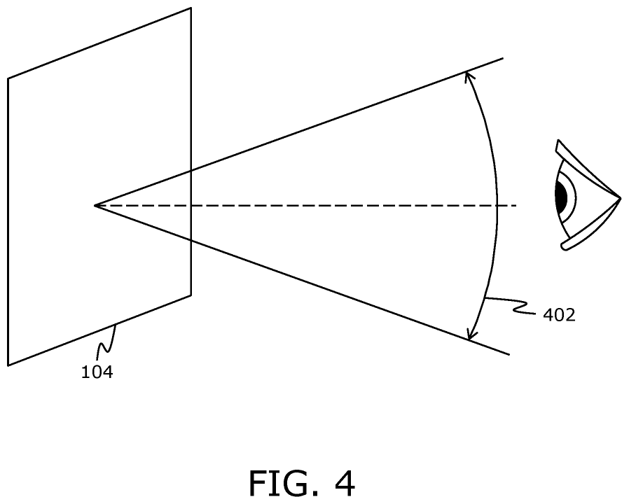

Referring to FIG. 4, illustrated is an exemplary implementation of a holographic optical element showing viewing angle 402, in accordance with some embodiments of the present disclosure. With reference to FIG. 4, there is shown a holographic optical element 104 and the viewing angle 402 based on the size of the holographic optical element 104. Notably, a small holographic optical element 104 will only allow the user to see the projected image from a specific position in front of it. Consequently, a large plate, on the other hand, increases the distance at which the image is projected, enlarging the field of vision.

In some embodiments, at least one of: movement of the virtual object, a second distance from the holographic optical element 104 at which the holographic image is provided, a size of the holographic image, a viewing angle of viewing the holographic image, depends on a size of the holographic optical element 104. Notably, a user may move 360 degrees around the holographic optical element but the viewing angle to view and visualize the hologram would be up to 150 degrees (at a time when at least one image source and the holographic optical element are at an angle of 90 degrees with one another). Moreover, the at least one virtual object represented in the provided holographic image would be able to move in the x axis, y axis and z axis contained within the size of the holographic optical element 104. Furthermore, a larger holographic optical element will in turn generate a bigger holographic image and a smaller holographic optical element will in turn generate a smaller holographic image. Optionally, a magnifying glass may be used in order to further expand the provided holographic image.

The interactive display system 100 is small in size and compact in construction. It is therefore portable and can be effectively used in a variety of practical use scenarios. In some practical use scenarios, the interactive display system could be implemented as an attachment that can be attached (securely) to the user device (for example, such as a smartphone, a tablet computer, a smart display, and the like). The interactive display system has several real-world applications and can be used effectively across several domains and industry settings. The interactive display system 100 not only displays holographic images, but also facilitates interaction between the holographic images and users. As an example, the interactive display system 100 may be used in general consumer applications. In such applications, the three-dimensional image may, for example, be a holographic avatar of the user that can be used to supplement virtual assistants (such as Siri, Alexa, and the like). This holographic avatar may interact with the virtual assistants. It will be appreciated that the processor 114 of the interactive display system 100 may work with existing AI technology of the virtual assistants, while optionally also employing its own AI in some instances. As another example, the interactive display system may be used for gaming applications. In such applications, the holographic image may, for example, be a virtual avatar of a player in an XR game (such as an augmented-reality game, a mixed-reality game, and the like). As yet another example, the interactive display system may be used in education domain, for example, in teaching and/or mentoring applications. In such an example, the holographic image may, for example, be a virtual teacher and/or mentor, a virtual educational model, and the like. As still another example, the interactive display system may be used in hospitality industry. In such an example, the holographic image may be that of a virtual waitress, a virtual concierge, and the like. As yet another example, the interactive display system 100 may be used in buildings (for example, such as conference centers, office complexes, malls, and the like). In such an example, the holographic image may, for example, be a virtual assistant that assists people to find offices, stores, restrooms, fire escape routes, and the like. As still another example, the interactive display system 100 may be used in retail industry. In such an example, the holographic image may, for example, be a virtual customer service assistant that may perform customer service tasks such as welcoming people, assisting people in locating items while shopping, giving directions to people for self-checkout, and the like. As yet another example, the interactive display system 100 may be used in restaurants. In such an example, the holographic image may, for example, be an avatar assisting people in bars, nightclubs, restaurants and the like with ordering food, drinks and streamlining the ordering process. Moreover, the interactive display system would display menus and an option to allow payment of the bill.

As an example, the holographic image may be a holographic avatar of the user. The user may customize the holographic avatar by selecting, via a touch input or voice input. It will be appreciated that customizing the holographic image encompasses customizing any characteristic (such as color, shape, size, texture, structure, design, and the like) of the holographic image.

As an example, a communication module of the user device sends the two-dimensional image associated with the video call to the processor 114 upon receiving an input (from the user) to either make the video call or receive the video call. Optionally, the conversion of the two-dimensional image associated with the video call into the three-dimensional image to be displayed is made in real time or near-real time. It will be appreciated that the conversion of the two-dimensional image to generate the holographic image may be implemented using any suitable image processing algorithm(s). As an example, a predefined depth may be added to the two-dimensional image for generating the holographic image. It will also be appreciated that the holographic image generated in such a manner may be displayed to provide a realistic and immersive video calling experience to the user.

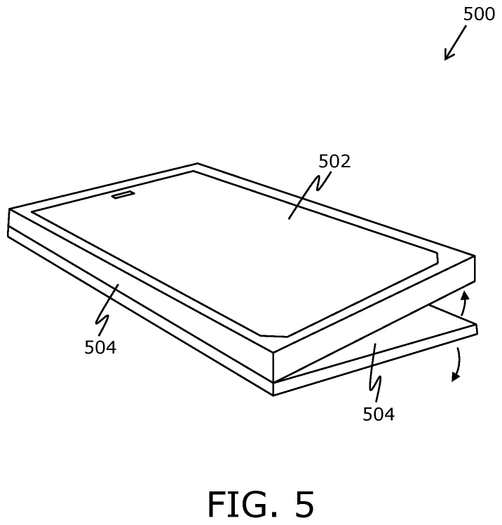

Referring to FIG. 5, illustrated is an exemplary implementation of a holographic optical element, in accordance with some embodiments of the present disclosure. With reference to FIG. 5, there is shown an interactive display system 500. A smartphone 502 acts as at least one image source and the holographic optical element 504 is attached to it like a foldable case 506. Notably, the holographic element 504 is first inserted to a foldable case 506 which in turn is attached to the smartphone 502. Moreover, the foldable case 506 is made to open (in clockwise direction) and close (in anti-clockwise direction) as and when needed. Furthermore, in an idle condition, the foldable case 506 along with the holographic element 504 will rest on the back side of the phone. When in use, the foldable case 506 maybe opened and kept at an angle between 30 degrees and 90 degrees with the smartphone 502 in order to view holographic images. It will be appreciated that the opening and closing mechanism may be achieved using a hinge mechanism, stand mechanism, locking mechanism, or any other means necessary. In some embodiments, at least one sensor may be attached to the foldable case 506.

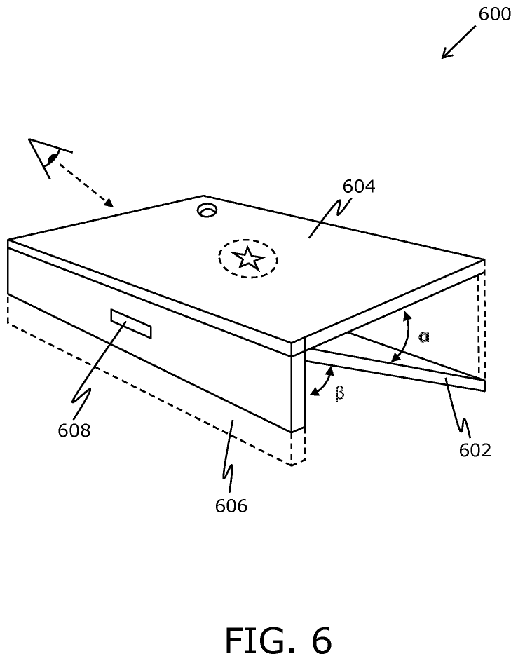

Referring to FIG. 6, illustrated is another exemplary implementation of a holographic optical element, in accordance with another embodiment of the present disclosure. With reference to FIG. 6, there is shown an interactive display system 600. A smartphone 602 acts as at least one image source and the holographic optical element 604 is attached to it like a foldable case. Notably, the foldable case is further removably attached with adjustable stand 606. The adjustable stand 606 adjusts the angle β. The angle β is created between the adjustable stand 606 and the smartphone 602. Moreover, an angle α is created between the smartphone 602 and the holographic optical element 604. The angle α ranges between 30 degrees to 90 degrees. Notably, in order to visualize better holographic images, the adjustable stand maybe adjusted as per the user height. A higher inclined case (and therefore the smartphone), the better angle of viewing for taller people. Furthermore, at least one sensor, such as sensor 608, may be incorporated within the stand such that it gets a clear view of the user and is in close proximity of the user. In this regard, when the angle α is at 90 degrees, the adjustable stand may not necessarily be open. In such a case, the adjustable stand may be present but in a closed position. Consequently, in such a case, the angle β between the adjustable stand 606 and the smartphone 602 is reduced to zero.

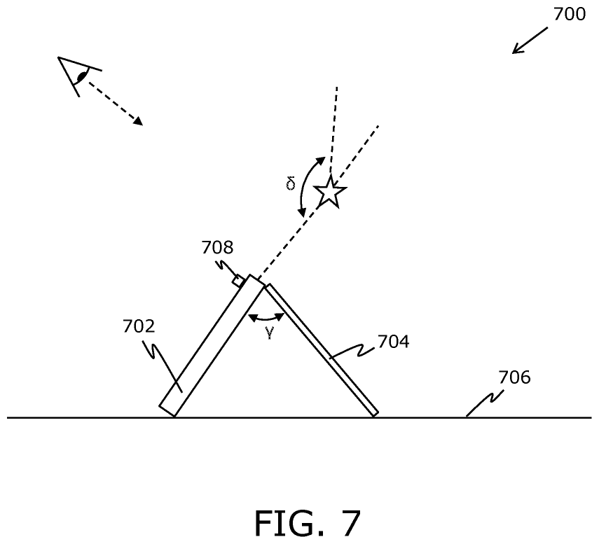

Referring to FIG. 7, illustrated is a side view of an exemplary implementation of a holographic optical element, in accordance with another embodiment of the present disclosure. With reference to FIG. 7, there is shown an interactive display system 700. A smartphone 702 acts as at least one image source and the holographic optical element 704 is attached to it like a foldable case. Herein, the angle γ between the holographic optical element 704 and the smartphone 702 is 90 degrees (maximum). Consequently, the viewing angle δ for a user to view the holographic image is up to 150 degrees. Notably, the user may move up and down with maximum 150 degrees in order to view the holographic image clearly. Notably, the foldable case along with the holographic optical element 704 rests on the back of the smartphone 702 in a closed position. When in use, the foldable case is opened to an angle of 270 degrees to reach the 90 degrees angle between the holographic optical element 704 and the smartphone 702. Herein, the angle between the smartphone 702 and a surface 706 is kept at 45 degrees. Furthermore, at least one sensor, such as sensor 708 is incorporated within the foldable case such that it gets a clear view of the user and is in close proximity of the user.

Optionally, in this regard, the combination of changing the angles between the smartphone (at least one image source) relative to the surface and the angle between the smartphone (at least one image source) and the holographic optical element determine the best viewing angle.

Optionally, the user interface is provided via a software application. The user may use the software application to seamlessly utilize the user interface. The software application is updated from time to time via cost-efficient technology updates.

Throughout the present disclosure, communicative coupling between any two components may be wired and/or wireless. Optionally, the communicative coupling may be made via a communication network.

Examples of the communication network may include, but are not limited to, Internet, a radio network, a Local Area Network (LAN), a Wide Area Network (WAN), a telecommunication network.

The method 800 introduces an effective way of interactively presenting a holographic image using an interactive display system. The method 800 is described in detail in following steps. At step 802, the method 800 comprises obtaining sensor data generated by at least one sensor, wherein the sensor data is indicative of an input. At step 804, the method 800 comprises processing the sensor data to determine the input. At step 806, the method 800 comprises generating an image, based on the input. At step 808, the method 800 comprises controlling at least one image source to display the image, wherein upon displaying, light rays emanating from the at least one image source are reflected by the holographic optical element when passing through the holographic optical element to provide the holographic image in air. The holographic optical element being arranged in use by the frame at a first distance from the at least one image source and obliquely with respect to the at least one image source, wherein the holographic image represents at least one virtual object.

The computer-readable medium comprising instructions which, when executed by a processor, cause the processor to perform the method of the present disclosure. Herein, the term “computer-readable medium” is a medium capable of storing data in a format readable and executable by the processor. Furthermore, the computer-readable medium may include magnetic media such as magnetic disks, cards, tapes, and drums, punched cards and paper tapes, optical discs, barcodes and magnetic ink characters. Additionally, common computer-readable medium technologies include magnetic recording, processing waveforms, and barcodes. Moreover, the term “processor” relates to a computational element that is operable to respond to and processes instructions that drive the computer-readable medium. Optionally, the processor includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “processor” may refer to one or more individual processors, processing devices and various elements associated with a processing device that may be shared by other processing devices. Additionally, the one or more individual processors, processing devices and elements are arranged in various architectures for responding to and processing the instructions that drive the system.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

Although the present invention has been described with reference to specific features and embodiments thereof, it is evident that various modifications and combinations can be made thereto without departing from the spirit and scope of the invention. The specification and drawings are, accordingly, to be regarded simply as an illustration of the invention as defined by the appended claims, and are contemplated to cover any and all modifications, variations, combinations or equivalents that fall within the scope of the present invention.

1.-15. (canceled)

16. An interactive display system comprising:
at least one image source;
a holographic optical element that is capable of converting images into holographic images;
a frame designed to accommodate the holographic optical element therein, wherein the frame, in use, arranges the holographic optical element at a first distance from the at least one image source and obliquely with respect to the at least one image source;
at least one sensor; and
a processor operably coupled to the at least one image source and the at least one sensor, wherein the processor is configured to:
obtain sensor data generated by the at least one sensor, wherein the sensor data is indicative of an input;
process the sensor data to determine the input;
generate an image, based on the input; and
control the at least one image source to display the image, wherein upon displaying, light rays emanating from the at least one image source are reflected by the holographic optical element when passing through the holographic optical element, to provide a holographic image in air, and wherein the holographic image represents at least one virtual object.

17. An interactive display system according to claim 16, wherein the input pertains to digital manipulation of the at least one virtual object represented by the holographic image, said digital manipulation comprising at least one of: creation of a given virtual object, removal of a given virtual object, resizing a given virtual object, changing a pose of a given virtual object, modifying a given virtual object, selection of a given virtual object from amongst a plurality of virtual objects.

18. An interactive display system according to claim 16, wherein, when processing the sensor data, the processor employs at least one of: an artificial intelligence algorithm, an image processing algorithm, an audio processing algorithm.

19. An interactive display system according to claim 16, wherein the holographic image is provided at a second distance from the holographic optical element, the second distance lying in a range of 80 percent to 120 percent of the first distance.

20. An interactive display system according to claim 16, wherein the holographic optical element is implemented as a transmissive reflector array comprising:
a first configuration of reflective elements, wherein a reflective surface of each reflective element is oriented in a first direction; and
a second configuration of reflective elements stacked on top of the first configuration, wherein a reflective surface of each reflective element is oriented in a second direction, the second direction being orthogonal to the first direction.

21. An interactive display system according to claim 16, wherein at least one of: movement of the virtual object, a second distance from the holographic optical element at which the holographic image is provided, a size of the holographic image, a viewing angle of viewing the holographic image, depends on a size of the holographic optical element.

22. An interactive display system according to claim 16, wherein a given sensor is arranged parallel to the at least one image source and at a third distance from the at least one image source, the third distance being different from the first distance.

23. An interactive display system according to claim 16, wherein the frame is detachably attachable to a device comprising the at least one image source.

24. An interactive display system according to claim 16, further comprising at least one output device, wherein the processor is configured to:
determine, based on the input, an output that is to be provided when displaying the image; and
control the at least one output device to provide the output at a time of displaying the image.

25. An interactive display system according to claim 16, wherein the processor is communicably coupled to a smart device that employs artificial intelligence, and wherein the processor is further configured to interface with the artificial intelligence of the smart device to at least control the smart device.

26. A method of producing a holographic image using an interactive display system, the interactive display system comprising at least one image source, a holographic optical element, a frame designed to accommodate the holographic optical element therein, and at least one sensor, the method comprising:
obtaining sensor data generated by the at least one sensor, wherein the sensor data is indicative of an input;
processing the sensor data to determine the input;
generating an image, based on the input; and
controlling the at least one image source to display the image, wherein upon displaying, light rays emanating from the at least one image source are reflected by the holographic optical element when passing through the holographic optical element to provide the holographic image in air, the holographic optical element being arranged in use by the frame at a first distance from the at least one image source and obliquely with respect to the at least one image source, wherein the holographic image represents at least one virtual object.

27. A method according to claim 26, wherein the step of processing the sensor data comprises employing at least one of: an artificial intelligence algorithm, an image processing algorithm, an audio processing algorithm.

28. A method according to claim 26, wherein the interactive display system further comprises at least one output device, and wherein the method further comprises:
determining, based on the input, an output that is to be provided when displaying the image; and
controlling the at least one output device to provide the output at a time of displaying the image.

29. A method according to claim 26, wherein the interactive display system is communicably coupled to a smart device that employs artificial intelligence, and wherein the method further comprises interfacing with the artificial intelligence of the smart device to at least control the smart device.

30. A computer program product for implementing a method of producing a holographic image using an interactive display system, the computer program product comprising a non-transitory machine-readable data storage medium having stored thereon program instructions that, when accessed by a processing device, cause the processing device to:
obtain sensor data generated by at least one sensor, wherein the sensor data is indicative of an input;
process the sensor data to determine the input;
generate an image, based on the input; and
control at least one image source to display the image, wherein upon displaying, light rays emanating from the at least one image source are reflected by a holographic optical element when passing through the holographic optical element to provide the holographic image in air, the holographic optical element being arranged in use by a frame at a first distance from the at least one image source and obliquely with respect to the at least one image source, wherein the holographic image represents at least one virtual object.
